(19) United States
(12) Patent Application Publication
(10) Pub. No.: US 2024/0281785 A1
(43) Pub. Date: Aug. 22, 2024

(54) EXTERNAL DISPLAY FOR A POINT OF SALE HOST

(71) Applicant: LABAU Technology Corp., New Taipei City (TW)

(72) Inventor: Jehng-Huei CHEN, New Taipei City (TW)

(21) Appl. No.: 18/348,504

(22) Filed: Jul. 7, 2023

(30) Foreign Application Priority Data
Feb. 18, 2023 (TW) 112201431

(51) Int. Cl. G06Q 20/20; G07G 1/14

(52) U.S. Cl. CPC G06Q 20/202; G07G 1/14

(57) ABSTRACT

An external display to be used with a point of sale (POS) host, including a serial data transmission interface that receives purchase information and an advertisement multimedia file from the POS host, a register memory module including a first section and a second section, a display memory module, a processor, a display screen and a display controller. The processor stores the purchase information in a first section and stores the advertisement multimedia file in a second section of the register memory module, accesses the register memory module to obtain the purchase information and the advertisement multimedia file, generates a composite multimedia file, and stores the composite multimedia file in the display memory module. The display controller obtains the composite multimedia file, and controls the display screen to display the purchase information and the advertisement multimedia file simultaneously thereon.

### CROSS-REFERENCE TO RELATED APPLICATION

This application claims priority to Taiwanese Utility Model Patent Application No. 112201431, filed on Feb. 18, 2023.

### FIELD

The disclosure relates to a display device, and more particularly to an external display that can be used with different point of sale (POS) hosts to constitute a POS system.

### BACKGROUND

FIG. 1 is a block diagram illustrating a conventional point of sale (POS) system 100. The POS system 100 includes a POS host 11, a main display screen 12 (e.g., a touchscreen), and a customer display device 13. The POS host 11 includes a processor 10, a data storage 16 that stores a graphical user interface (GUI) and a POS software application therein, and a scanner 18. The POS software application includes instructions that, when executed by the processor 10, causes the processor 10 to implement the operations associated with the POS system 100.

The main display screen 12 is coupled to the POS host 11 via an audio/video interface 14 (e.g., High-Definition Multimedia Interface (HDMI®)), and is controlled by the POS host 11 to display the GUI, which is provided by the POS host 11, for allowing a cashier to operate thereon by touching the main display screen 12. The customer display device 13 is coupled to the POS host 11 via a serial data transmission interface 15 (e.g., a Universal Serial Bus (USB) interface), and is configured to display purchase information associated with a purchase (e.g., a name of merchandise scanned by the scanner 18, a number of the merchandise purchased, a unit price, and a total price calculated by the processor 10, etc.) for a customer. Typically, the customer display device 13 is embodied using a display device with a resolution that is relatively low, and is only configured for displaying basic information such as the display purchase information.

FIG. 2 is a block diagram illustrating another conventional POS system 200. The POS system 200 includes a POS host 21, a first display screen 22 (e.g., a touchscreen), and a second display screen 23. The POS host 21 includes a processor 20, a data storage 26 that stores the GUI, the POS software application and at least one advertisement multimedia file (which may be an image, a video, etc.) containing advertisement material therein, and a scanner 28.

The first display screen 22 is coupled to the POS host 21 via a first audio/video interface 24 (e.g., High-Definition Multimedia Interface (HDMI®)), and is controlled by the POS host 21 to display the GUI, which is provided by the POS host 21, for allowing a cashier to operate thereon by touching the first display screen 22. The second display screen 23 is coupled to the POS host 21 via a second audio/video interface 25 (which may be similar to the first audio/video interface 24), and is configured to display purchase information associated with a purchase (e.g., a name of merchandise scanned by the scanner 18, a number of the merchandise purchased, a unit price, a total price calculated by the processor 10, etc.) for a customer. Specifically, in this example, the processor 20 may incorporate the purchase information and advertisement multimedia file to generate a composite multimedia file, and transmit the composite multimedia file to the second display screen 23. As such, in addition to the purchase information, a customer is able to view the advertisement multimedia file simultaneously on the second display screen 23. It is noted that the second display screen 23 is typically more advanced in comparison to the customer display device 13 shown in FIG. 1, and is capable of displaying the advertisement multimedia file adequately.

In some cases, it may be desired to use the POS system 100 of FIG. 1 to implement the function of displaying the composite multimedia file as in the POS system 200 (as shown in FIG. 2). As such, FIG. 3 is a block diagram of another POS system 100′ which is an upgraded version of the conventional POS system 100. Specifically, the POS host 11 further includes an additional audio/video interface 17 (which may be similar to the audio/video interface 14), and the POS system 100′ further includes an additional display 19 that has a specification similar to that of the main display screen 12 and that is connected to the POS host 11 via the additional audio/video interface 17. The data storage 16 further stores at least one advertisement multimedia file containing advertisement material therein. In use, the purchase information is transmitted via the serial data transmission interface 15 to the customer display device 13 for display, and the advertisement multimedia file is transmitted via the additional audio/video interface 17 to the additional display 19 for display. To achieve this, the POS host 11 may also need modification and/or upgrades. For example, the POS software application stored in the POS host 11 may need to be updated or replaced to accommodate the change.

### SUMMARY

One object of the disclosure is to provide an external display that can be used with a point of sale (POS) host to form a POS system. Specifically, the POS host may be one with

According to one embodiment of the disclosure, the external display is to be used with a POS host. The external display includes:
a serial data transmission interface that enables a wired connection between the POS host and the external display, so as to receive purchase information associated with a purchase and an advertisement multimedia file from the POS host;
a register memory module including a first section and a second section;
a display memory module;
a processor connected to the serial data transmission interface, the register memory module and the display memory module;
a display controller connected to the display memory module, and
a display screen connected to the display controller;
wherein the processor is configured to
   in response to receipt of the purchase information and the advertisement multimedia file, storing the purchase information in one of the first section and a second section of the register memory module and storing the advertisement multimedia file in the other one of the first section and the second section of the register memory module,
   access the register memory module to obtain the purchase information and the advertisement multimedia file, and generate a composite multimedia file based on the purchase information and the advertisement multimedia file, and
   store the composite multimedia file in the display memory module,
wherein the display controller is configured to access the display memory module to obtain the composite multimedia file, and to control the display screen to display the purchase information and the advertisement multimedia file simultaneously thereon.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a conventional point of sale (POS) system.

FIG. 2 is a block diagram illustrating another conventional POS system.

FIG. 3 is a block diagram illustrating further another conventional POS system which is an upgraded version of the conventional POS system of FIG. 1.

FIG. 4 is a block diagram illustrating an external display to be used with a POS host and a main display screen according to one embodiment of the disclosure.

FIG. 5 is a block diagram illustrating an external display to be used with a POS host, which is a different model from the POS host of FIG. 4, and a main display screen according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

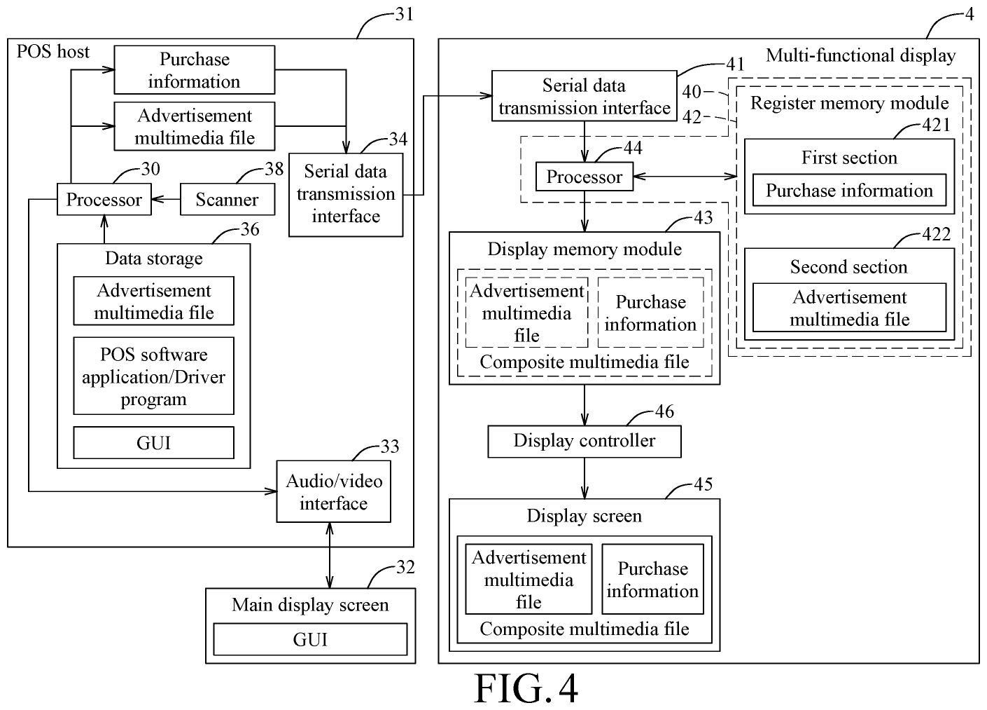

FIG. 4 is a block diagram illustrating an external display 4 to be used with a point of sale (POS) host 31 that is electrically connected with a main display screen 32 according to one embodiment of the disclosure. Typically, the POS host 31, the main display screen 32 and the external display 4 collectively form a POS system.

In this embodiment, the POS host 31 may be embodied using a computing device, and includes a processor 30, an audio/video interface 33 (e.g., High-Definition Multimedia Interface (HDMI®)), a serial data transmission interface 34 (e.g., a Universal Serial Bus (USB) interface), a data storage module 36, and a scanner 38.

The processor 30 may include, but is not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

The data storage module 36 is connected to the processor 30, and may be embodied using, for example, random access memory (RAM), read only memory (ROM), programmable ROM (PROM), firmware, and/or flash memory, etc. The data storage module 36 stores a graphical user interface (GUI), a POS software application and at least one advertisement multimedia file (which may be an image, a video, etc.) containing advertisement material therein. In this embodiment, the data storage module 36 stores a plurality of advertisement multimedia files containing the advertisement material associated with different categories of merchandise, respectively. The POS software application includes instructions that, when executed by the processor 30, cause the processor 30 to perform the operations as described below.

The scanner 38 is connected to the processor 30, and is configured to scan a barcode (e.g., a two-dimensional (2D) code) attached to a merchandise, and as such, the processor 30 is configured to determine the content included in the 2D code. In use, the scanner 38 may be embodied using a commercially available scanner.

The main display screen 32 may be embodied using a touch screen, is connected to the POS host 31 via the audio/video interface 33, and is controlled by the POS host 11 to display the GUI, which is provided by the POS host 11, for allowing a cashier to operate thereon by touching the main display screen 32.

The external display 4 includes a serial data transmission interface 41, a register memory module 42, a display memory module 43, a processor 44, a display screen 45, and a display controller 46.

The serial data transmission interface 41 may be embodied using components that are similar to those of the serial data transmission interface 34 (e.g., another USB interface), so as to enable a wired connection between the external display 4 and the POS host 31 using, for example, a USB cable.

The register memory module 42 may be embodied using a register memory of a microcontroller 40, a built-in memory of the external display 4, or an externally connected memory module. The register memory module 42 includes a first section 421 and a second section 422. In this embodiment, the first section 421 and the second section 422 are two sections that are included in the same register memory module 42 but are separate from each other, while in other embodiments, the first section 421 and the second section 422 may be embodied using two separate memory modules.

The display memory module 43 may be embodied using a memory included in a built-in video card (not depicted in the drawings) of the external display 4, a built-in memory of the external display 4, or an externally connected memory module.

The processor 44 is connected to the serial data transmission interface 41, the register memory module 42 and the display memory module 43, and may be embodied using a central processing unit (CPU) of the microcontroller 40 of the external display 4 in this embodiment, but is not limited to such.

The display screen 45 may be embodied using a liquid crystal display (LCD) screen or a touch screen.

The display controller 46 may be embodied using a video display controller (VDC), a graphics processing unit (GPU), or a controller included in the built-in video card, and is connected to the display memory module 43 and the display screen 45, and is configured to access data stored in the display memory module 43 and to transmit the data to the display screen for display.

In use, the POS host 31 may first download and store a driver program related to the external display 4, and after executing the driver program, the processor 30 is capable of interacting with the external display 4.

Specifically, the POS system including the POS host 31, the main display screen 32 and the external display 4 may be placed in a retail store, a department store, or other locations, and may be handled by a cashier. The GUI is transmitted by the POS host 31 to the main display screen 32

In the case that a customer intends to make the purchase that may include one or more merchandises, he/she may proceed to the POS system. Then, at the POS system, a check-out process is started, and the cashier places the merchandise near the scanner 38 to read a barcode (e.g., a two-dimensional (2D) code) that is attached to the merchandise facing the scanner 38. As a result, merchandise information encoded in the 2D code (e.g., information of the merchandise, such as a name and a price) is scanned by the scanner 38 and obtained by the processor 30, and the processor 30 generates purchase information based on the merchandise information obtained from the scanner 38. It is noted that the purchase information may be updated as 2D code of additional merchandise is scanned by the scanner 38, or as merchandise is cancelled from purchase.

During the check-out process, the processor 30 is configured to transmit the GUI to the main display screen 32 via the audio/video interface 33, and to transmit the purchase information and one of the advertisement multimedia files to the external display 4 via the serial data transmission interface 34. In this embodiment, the purchase information and the advertisement multimedia file may be transmitted to the external display 4 in the form of one or more packets that can be received and parsed by the external display 4, and the selection of one of the advertisement multimedia files may be based on the purchase information.

In response to the receipt of the packet(s), the processor 44 is configured to process the packet(s) to extract the purchase information and the advertisement multimedia file, and to store the purchase information and the advertisement multimedia file in the register memory module 42. Specifically, in this embodiment, the processor 44 is configured to store the purchase information in the first section 421, and to store the advertisement multimedia file in the second section 422.

Then, the processor 44 is configured to access the register memory module 42 to obtain the purchase information and the advertisement multimedia file stored therein. Next, the processor 44 is configured to integrate the purchase information and the advertisement multimedia file, so as to generate a composite multimedia file, and to transmit the composite multimedia file to the display memory module 43 that includes the purchase information and the advertisement multimedia file.

The display controller 46 is configured to access the display memory module 43 to obtain the composite multimedia file, and to control the display screen 45 to display the composite multimedia file. It is noted that during the check-out process, additional merchandise may be added, the purchase information included in the composite multimedia file (and therefore the content of the composite multimedia file to be displayed by the display screen 45) may be changed accordingly. In embodiments, the composite multimedia file may be displayed in different manners. For example, in this embodiment, the advertisement multimedia file may be displayed on a left side of the display screen 45, and the purchase information may be displayed on a right side of the display screen 45, but is not limited to such.

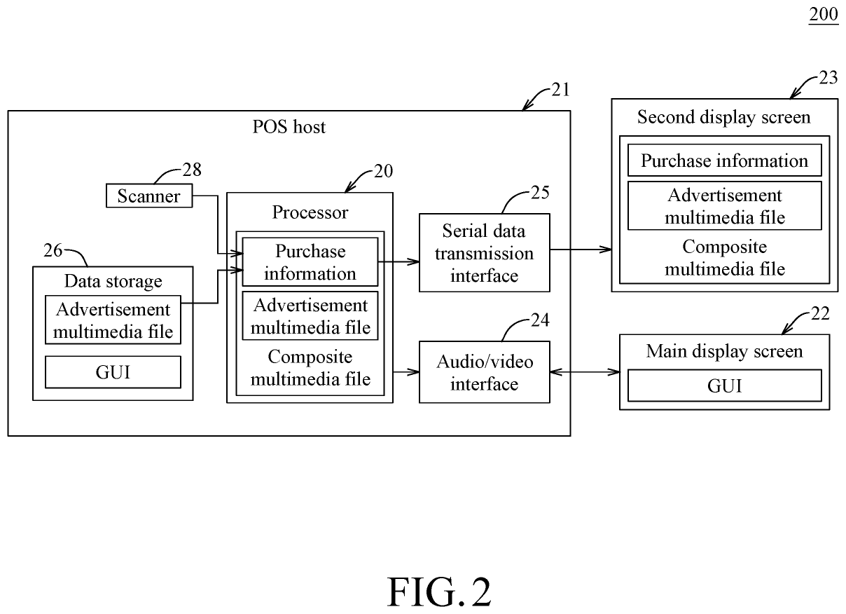

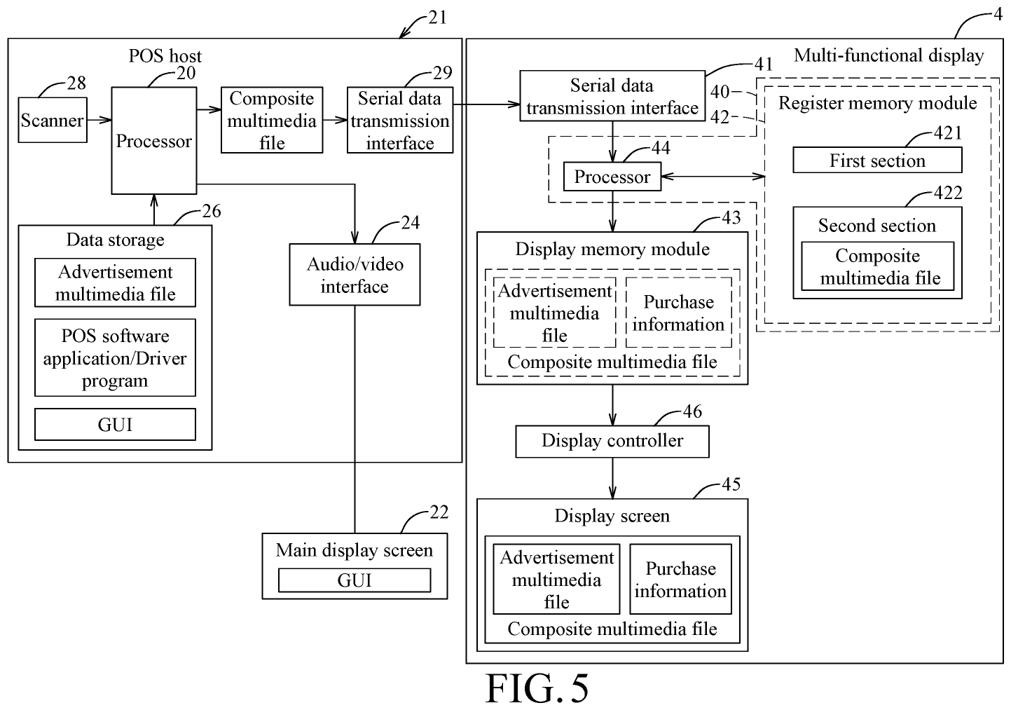

FIG. 5 is a block diagram illustrating an external display 4 to be used with a POS host 21′, which is a different model from the POS host 31 shown in FIG. 4 but similar to the POS host 21 shown in FIG. 2, and a main display screen 22? according to one embodiment of the disclosure. In this embodiment, the POS host 21′ may be embodied using a computer device, and includes a processor 20, an audio/video interface 24′ (e.g., HDMI®), a data storage 26 that stores the GUI, the POS software application and at least one advertisement multimedia file therein, a scanner 28, and a serial data transmission interface 29 (e.g., a USB Type-C® interface). The main display screen 32 is coupled to the POS host 21′ via the audio/video interface 24′.

The external display 4 is connected to the POS host 21′ via the serial data transmission interface 41 and the serial data transmission interface 29. In this embodiment, the POS host 21′ is configured to generate the composite multimedia file, and to transmit the composite multimedia file to the external display 4, instead of directly transmitting the purchase information and the advertisement multimedia file to the external display 4. In response to receipt of the composite multimedia file, the processor 44 stores the composite multimedia file in the register memory module 42 (e.g., in the second section 422).

Then, the processor 44 is configured to access the register memory module 42 to obtain the composite multimedia file stored therein. Then, the processor 44 is configured to store the composite multimedia file in the display memory module 43.

The display controller 46 is configured to access the display memory module 43 to obtain the composite multimedia file, and to control the display screen 45 to display the composite multimedia file.

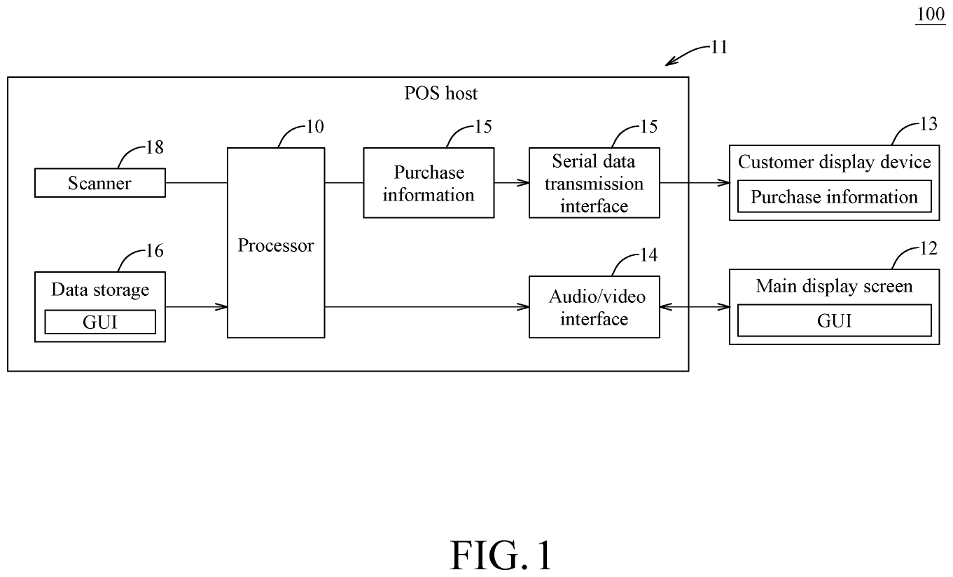

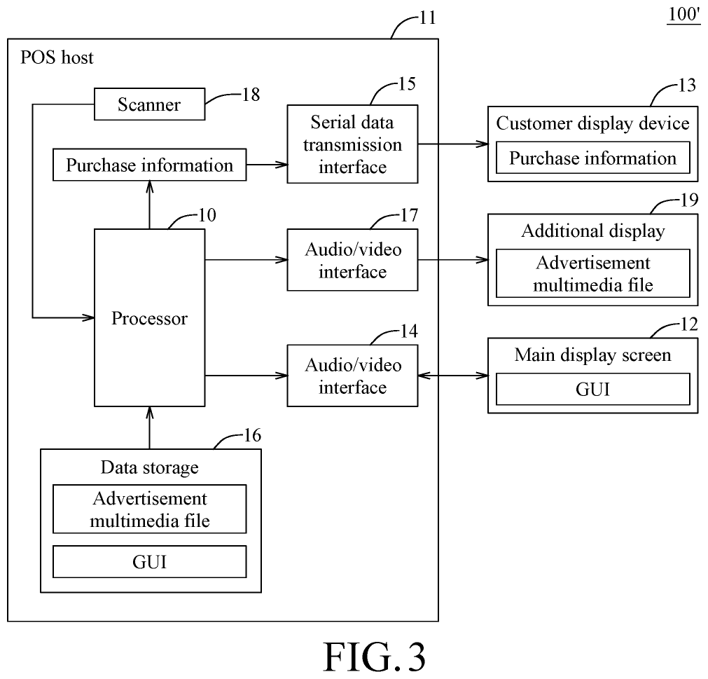

To sum up, embodiments of the disclosure provide an external display that is configured to be used with different models of the POS host to form a POS system. In use, when connected to the external display, the POS host is configured to transmit the purchase information and the advertisement multimedia file, or a composite multimedia file, to the external display via a serial data transmission interface. In response to receipt of the data from the POS host, the external display is configured to generate a composite multimedia file based on the purchase information and the advertisement multimedia file and control a display screen to display both the purchase information and the advertisement multimedia file of the composite multimedia file simultaneously, or to directly display the composite multimedia file received from the POS host. In this manner, the POS system may be operated without having to replace the POS host to include multiple audio/video interfaces or having to include more than two display devices (as the example shown in FIG. 3). Additionally, the POS host only needs to load a driver program related to the external display, and the POS software application need not be updated. As such, the external display is capable of functioning together with various POS hosts of different models, a conventional POS system (as described in FIG. 1) may be upgraded with a relatively low cost.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An external display to be used with a point of sale (POS) host, comprising:
a serial data transmission interface that enables a wired connection between the POS host and the external display, so as to receive purchase information associated with a purchase and an advertisement multimedia file from the POS host;
a register memory module including a first section and a second section;
a display memory module;
a processor connected to the serial data transmission interface, the register memory module and the display memory module;
a display controller connected to the display memory module, a display screen connected to the display controller; and
wherein the processor is configured to
in response to receipt of the purchase information and the advertisement multimedia file, storing the purchase information in one of the first section and a second section of the register memory module and storing the advertisement multimedia file in the other one of the first section and the second section of the register memory module,
access the register memory module to obtain the purchase information and the advertisement multimedia file, and generate a composite multimedia file based on the purchase information and the advertisement multimedia file, and
store the composite multimedia file in the display memory module,
wherein the display controller is configured to access the display memory module to obtain the composite multimedia file, and to control the display screen to display the purchase information and the advertisement multimedia file simultaneously thereon.

2. The external display as claimed in claim 1, wherein the serial data transmission interface is a Universal Serial Bus (USB) interface.

3. The external display as claimed in claim 1, wherein: the external display further comprises a microcontroller, and the processor is a central processing unit (CPU) of the microcontroller.

4. The external display as claimed in claim 3, wherein the register memory module is a register memory included in the microcontroller.

5. The external display as claimed in claim 1, wherein the first section and the second section are separate from each other.
